(19) United States
(12) Patent Application Publication
(10) Pub. No.: US 2020/0339240 A1
(43) Pub. Date: Oct. 29, 2020

(54) REMOVABLE TINTED WINDOW PANELS FOR AIRCRAFT COCKPIT WINDOWS

(71) Applicant: Jet Shades, LLC, Jupiter, FL (US)

(72) Inventor: Kevin J. Duggan, Jupiter, FL (US)

(73) Assignee: Jet Shades, LLC, Jupiter, FL (US)

(21) Appl. No.: 16/924,904

(22) Filed: Jul. 9, 2020

Related U.S. Application Data
(63) Continuation-in-part of application No. 16/199,105, filed on Nov. 23, 2018.
(60) Provisional application No. 62/590,425, filed on Nov. 24, 2017.

(51) Int. Cl. B64C 1/14; B60J 1/20

(52) U.S. Cl. CPC B64C 1/1492; E06B 2009/2488; B60J 1/2091

(57) ABSTRACT

A cockpit window panel that is easily installed and removed that reduces glare and heat and improves overall cockpit environment and pilot comfort. The panels include a clear polycarbonate sheet contoured to match an aircraft window, a bonding film applied to the polycarbonate sheet and a tinted film applied to the bonding film. The polycarbonate panel is bound by a flexible trim having a channel frictionally received over the peripheral edge of the panel and a conformable gasket that engages the interior window ledges when the panel is in an installed position. At least one pull tab is provided along the edge of the panel. The panels are easily installed by simply pressing them into place within the window well and secured by friction through the conformable gasket trim.

### CROSS-REFERENCE TO RELATED APPLICATIONS

This application is a continuation-in-part of and claims benefit to U.S. patent application Ser. No. 16/199,105, filed Nov. 23, 2018, which is related to and claims priority from earlier filed U.S. Provisional Patent Application No. 62/590,425, filed Nov. 24, 2017, both of which are incorporated herein by reference in their entirety.

### BACKGROUND OF THE INVENTION

The present invention relates generally to aircraft cockpit windows. More specifically, the present invention relates to removable tinted panels for installation in aircraft cockpit windows that reduce glare and heat inside the cockpit

There are currently no available removable window panels for aircraft cockpit windows. Most aircraft cockpit windows are clear glass to provide for optimum visibility. However, aircraft cockpits are subject to unique glare and heat issues both on the ground and more particularly while flying. While on the ground, many aircraft sit exposed to the sun for extended periods of time either during storage or simply while awaiting takeoff. Glare obscures the aircraft navigation display panels, which are mostly electronic LCD displays. Further, heat quickly builds up in the small cockpit areas from exposure to direct sun. While in the air, the aircraft is exposed to higher UV indexes and experiences greater glare than while on the ground.

The FAA strictly regulates any permanent modifications to the aircraft such as directly tinting the windows or permanently installing any type of shade. Accordingly, there is a need in the industry for a solution which can be easily implemented without a permanent installation within the aircraft.

### BRIEF SUMMARY OF THE INVENTION

In this regard, the present invention provides for a unique cockpit window panel that is easily installed and removed to comply with FAA regulations. The panel, when installed, reduces glare and heat, and improves overall cockpit environment and pilot comfort. The panels allow the pilot to selectively block the sun when needed to remove glare and to remove the discomfort of being exposed to direct sunlight coming from the side windows. The panels reduce pilot fatigue, reduce eye strain, and increase pilot performance and comfort.

The panels generally comprise a clear polycarbonate sheet which has an outer peripheral edge that is contoured to match a substantially similar same shape as the interior enclosure of the aircraft window but is slightly smaller. A bonding film is applied to the inner surface of the polycarbonate panel, and a tinted, anti-glare film applied to the bonding film. The bonding film acts as an intermediary bridging film between the polycarbonate and the tinted film as the polycarbonate material tends to off-gas when heated and does not interact well with the tinted film. The polycarbonate panel is bound by a flexible trim having a U-shaped channel which is frictionally received over the peripheral edge of the panel and a conformable gasket, more preferably a tubular sponge rubber gasket extends from the channel and engages the interior window ledges when the panel is in an installed position. At least one pull tab is provided along the edge of the panel. Preferably, pull tabs are provided at the bottom and top of the panel for easy removal.

The key aspect of the window panels is that they are easily installed by simply pressing them into place within the window well, but also easily removable. When the sun is causing too much glare on the instrument panel, or discomfort to the pilot, the panels can be quickly press fit into place and secured by friction through the conformable gasket trim.

The design and pull tabs also allow a “quick-look” feature which enables the pilot to grasp the top center pull tab and rotate the top half of the panel downwardly without fully removing the panel, allowing a view through the virgin aircraft window as needed. Afterward, the pilot can simply press fit the window panel back into place.

No additional fastening mechanisms are required. The thickness of the panel and the fit of the conformable tubing gaskets allows the panel to securely press fit into place. The panels will not come loose in light, moderate or severe turbulence.

The exemplary window panels provide a 36% reduction in solar energy in the cockpit, block 80% of light transmission, block 98% of UV transmission and reduce glare by 79%. Testing has revealed that use of the windows panels reduces the interior temperature of the cockpit by at least 10 degrees F. as compared to a cockpit without the windows panels.

It is therefore an object o the invention to provide a glare shade panel for aircraft cockpits that is easy to install and remove while providing improved glare reduction and decreased radiational heating of the cockpit.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a plan view of an exemplary embodiment of a removable cockpit window panel in accordance with the teachings of the present invention;

FIG. 2 is a cross-sectional view of the panel taken along line 2-2 of FIG. 1;

FIG. 3 is an enlarged view of one of the pull tabs;

FIG. 4 is an image of an exemplary window panel installed in the side cockpit window next to the pilot's station;

FIG. 5 is another image thereof;

FIG. 6 is an image of the cockpit instrument panel showing significant glare without the present panel installed;

FIG. 7 is another image thereof showing reduced glare and better visibility of the instrument panel with the present panel installed;

FIG. 8 is a plan view of a second exemplary embodiment of a removable cockpit window panel in accordance with the teachings of the present invention; and

FIG. 9 is a plan view of the second exemplary embodiment of FIG. 8 in a second, folded, configuration.

### DETAILED DESCRIPTION OF THE INVENTION

Now referring to the drawings, the tinted window panel assembly is shown and generally illustrated at 10 in the figures. As can be seen the tinted window panel assembly 10 generally comprises a tinted polymer panel 12 bordered by a conformable gasket trim 5.

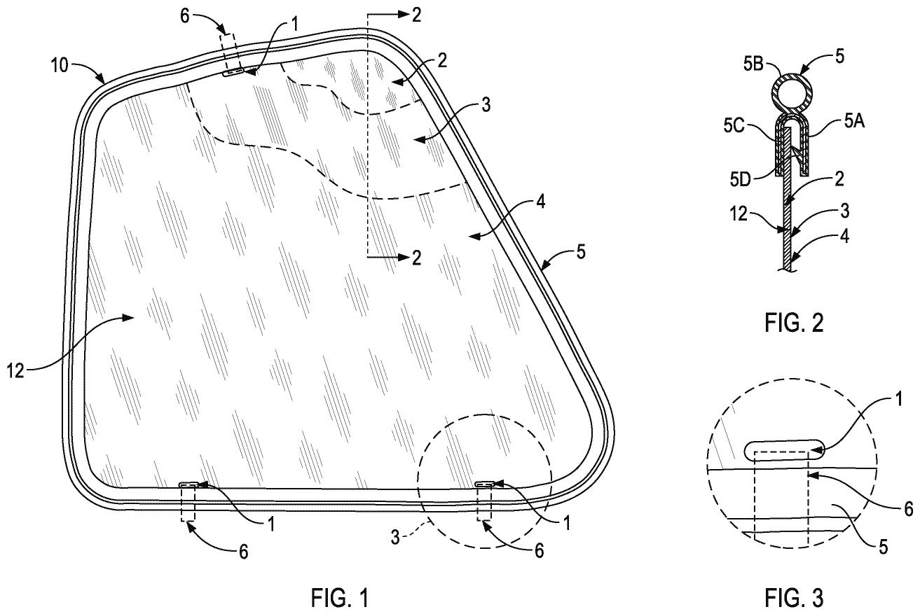

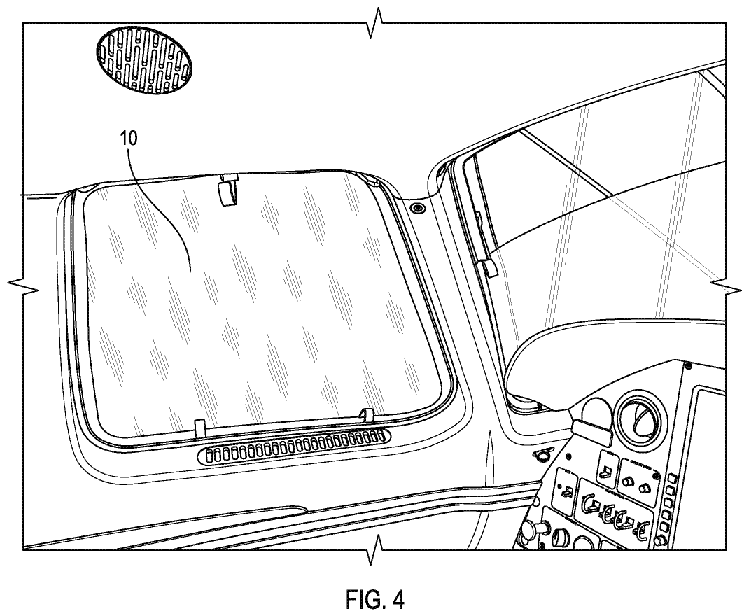

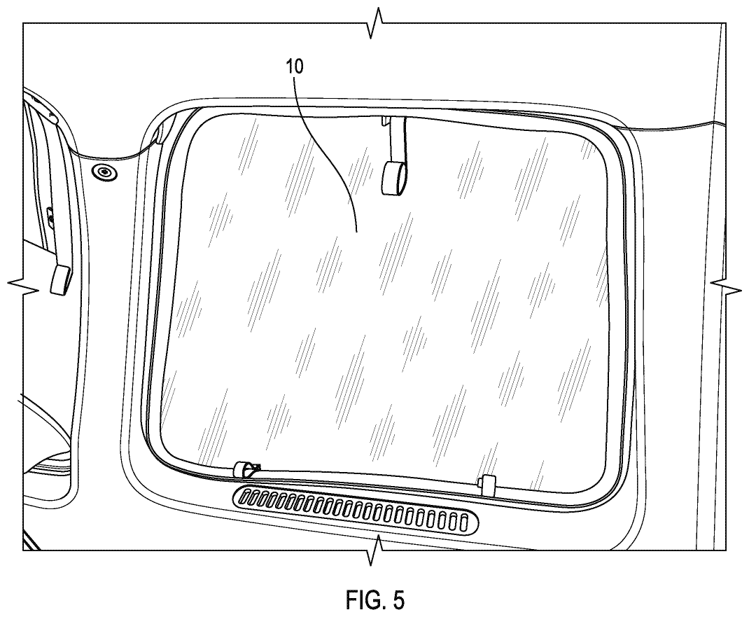

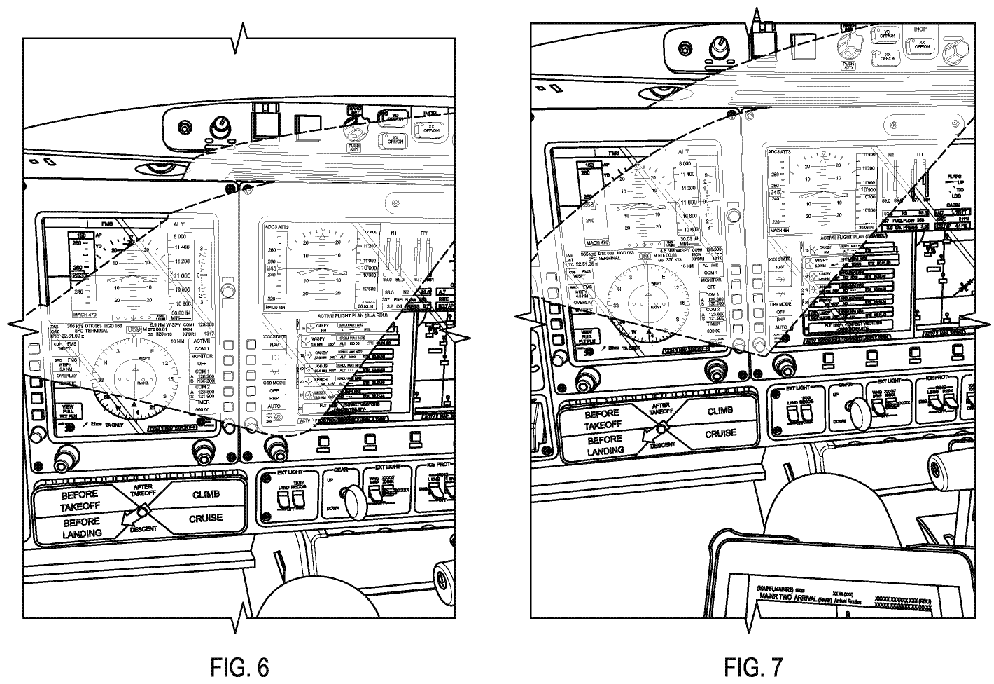

Referring to FIGS. 1 and 2, the polymer panel 12 comprises a flexible, clear polycarbonate sheet 2 having an outer peripheral edge that follows the same shape as and interior window well of the aircraft window into which the window panel assembly 10 is meant to be installed but is slightly smaller (See FIGS. 4-5). Each panel must be custom shaped for a particular aircraft window. The panels may be used in any aircraft window such as the side windows or the main viewing windows.

An exemplary type of polycarbonate sheet suitable for use as the clear polycarbonate sheet 2 is Makrolon® GP polycarbonate having a thickness of 0.062. Makrolon® GP® is a general-purpose polycarbonate material that has a polished surface. It is UV stabilized, transparent, has high impact strength, superior dimensional stability, high temperature resistance and high clarity. The thickness of the sheet may vary according to the overall size of the window to provide a proper amount of flexibility, i.e. a larger window panel may need to be thicker to provide a suitable level of rigidity/flexibility while a smaller window could potentially require a thinner sheet.

A polyethelyne teraphthalate (PET) bonding film 3 is applied to the inner surface of the polycarbonate panel 2, and a PET tinted, anti-glare film 4 applied to the bonding film 3.

An exemplary type of PET bonding film 3 is Madico® Solution Series Blister Free 2 Mil film which is a clear film specifically for polycarbonate substrates that allows for solar control or decorative films to be applied. Polymeric substrates such as polycarbonate and acrylic absorb moisture on high humidity days and exude that moisture vapor on low humidity days, leading to the blistering of standard film products. Madico's Blister Free film offers a proprietary adhesive that is not affected by the absorption and release of this moisture and remains intact.

An exemplary type of anti-glare film 4 is Madico® Black Pearl NR film having a at least some level of visible light blocking properties. More preferably the film has visible light blocking properties of between about 60% and 95% translating to a Visible Light Transmission (VLT) of between about 45% and 5%. More preferably film has a light blocking of about 75% at a VLT of about 25% and a more preferably the film has light blocking of about 95% at a VLT of about 5%. The outwardly facing surface of the tinted film is scratch resistant.

In preparing the panel 12, the intermediate bonding film 3 is first applied to the polycarbonate and allowed to cure for 6-10 days, preferably about 7 days, in a curing environment. Thereafter, the tinted film 4 is applied over the bonding film 3 and is allowed to cure for an additional 2-4 days, preferably 3 days, in a curing environment. The particular films, and application methods are critical to long term durability of the panel assembly.

The bonding film 3 acts as an intermediary bridging film between the polycarbonate panel 2 and the tinted film 4 as the polycarbonate material tends to off-gas and form bubbles between itself and a film attached thereto when heated and does not interact well with the PET tinted film 4.

The polycarbonate panel 2 is bound by a flexible trim 5 having a channel portion 5A which is frictionally received over the peripheral edge of the panel 12 and a conformable, compressible gasket portion 5B extending from the channel 5A which engages the interior window ledges. The channel portion 5A is a flexible polyvinylchloride (PVC) material (85 Shore A Durometer) and includes an internal aluminum spring clip 5C (Aluminum 3004 H38P) to insure long term spring pressure on the facing walls of the panel 12. Preferably, both the channel 5A and the spring clip 5C are substantially U-shaped although any shape that is suitable to allow the gasket to be installed and retained on the edge of the panel would be considered to fall within the scope of the disclosure. Still further, the channel portion 5A may also include an inwardly angled blade gasket 5D on one or both internal walls of the channel.

The width of the channel 5A is matched to the thickness of the panel 12 to provide a firm secure grip on the sides of the panel 12 without distorting the films 2, 3 when pressed over the peripheral edge. The gasket portion 5B is preferably a tubular shaped ethylene propylene diene monomer (EPDM) sponger rubber material which collapses to take on the shape of the window well and allows for differences in manufacturing tolerances from aircraft to aircraft. The sponge rubber gasket tightens around the corners of the panel which allows for air flow past the panel to reduce condensation and fogging which may occur during a descent in a humid environment.

One aspect of the window panels is that they are easily installed by simply pressing them into place within the window interior trim, but also easily removable. (See FIGS. 4-5) When the sun is causing too much glare on the instrument panel, or discomfort to the pilot, the panels can be quickly press fit into place and secured by friction through the conformable gasket trim.

At least one pull tab 6 is provided. Preferably two pull tabs are positioned toward the opposing bottom sides of the panel and the top middle of the panel for easy grasping and removal. Exemplary embodiments of the pull tabs are fabric or plastic strips which extend through slots 1 in the tinted panel. The design and pull tabs 6 allow a “quick-look” feature which enables the pilot to grasp the top center pull tab and rotate the top half of the panel downwardly without fully removing the panel, allowing a view through the virgin window as needed. Afterward, the pilot can simply press fit the window panel back into place.

To facilitate the “quick-look” downward tilting of the top portion of the panel assembly 10, the outward dimensions of the window panel 12 relative to the size of the intended aircraft window well are slightly larger at the bottom of the panel and are smaller at the top of the panel. This sizing allows the gasket to compress slightly more at the bottom creating a tighter fit to keep the bottom portion of the panel in place when tilting the panel down to see through the virgin cockpit window.

It can therefore be seen that the exemplary embodiments provide a unique and novel removable cockpit window panel which meets FAA regulations and improves the comfort and environment conditions of the cockpit. The exemplary window panels provide a 36% reduction in solar energy in the cockpit, block 65-95% of visible light, block 98% of UV transmission and reduce glare by 79%. An exemplary improvement in glare is clearly seen by comparing FIGS. 5 (no panel) and 6 (panel installed). Applicant testing reveals that use of the windows panels reduces the interior temperature of the cockpit by at least 10 degrees F. as compared without the windows panels.

In an alternative embodiment, the tinted window panel assembly 110 can be sectioned into two, or more, sections, and have at least one hinge disposed between each section. Advantageously, in the alternative embodiment, the sectioned window panel assembly 110 can be folded into a smaller area for increased portability. These panels can be stored in a folded conditioned in a travel case so that pilots can carry them from plane to plane as they work. The alternative window panel assembly 110 is substantially the same as the window panel assembly 10, thus only the sections and hinges shown herein will be discuss for brevity sake.

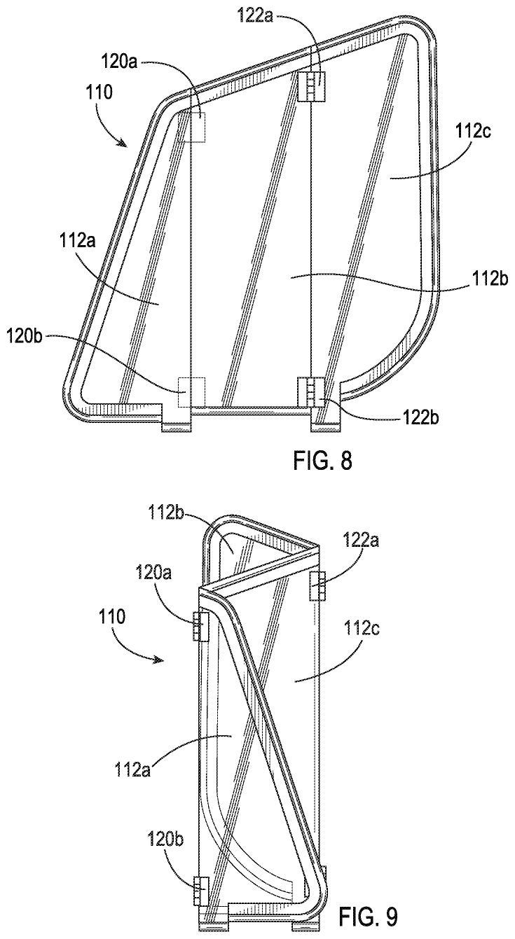

As shown in FIGS. 8 and 9, the tinted window panel assembly 110 can, in general, have three distinct sections 112a, 112b, and 112c. Each of the three sections 112a-c can be of equal or different lengths, depending on the design of the window for which the panel assembly 110 is being used with. In the illustrated embodiment, the sections 112a, 112b can be connected via two hinges 120a, 120b both disposed on a first side of the panel assembly 110 to allow the first panel 112a to rotate up and out of the page, relative to FIG. 8, towards the second panel 112b in a direction R1. The two hinges 120a, 120b can be disposed on a top and bottom of the two sections 112a, 112b.

Similarly, a second set of hinges 122a, 122b can be disposed between the second and third panels 112b, 112c on a second side of the panel assembly 110. The second set of hinges 122a, 122b can allow the third panel 112c to rotate down and into the page, relative to FIG. 8, towards the second side of the second panel 112b in a direction R2. The second set of hinges 122a, 122b can be disposed on a top and bottom of the two sections 112b, 112c.

While two hinges 120a, 120b and 122a,122b are shown between the first and second panels 112a, 112b and the second and third panels 112b, 112c, any number of hinges can be used. Further while the first set of hinges 120a, 120b are shown on a first side of the panel assembly 110 and the second set of hinges 122a, 122b on the opposite side of the panel assembly 110, the two sets of hinges can be disposed on the same side. Further, in some embodiments the hinges 120a, 120b, 122a, 122b can be adhesive hook and loop material that are adhered to the respective surfaces of the panel assembly 110. When the first, second, and third panels 112a-c are folded together, as shown in FIG. 9, the hook and loop material can secure the folded panels together such that the panel assembly does not unfold when not in use.

In other exemplary embodiments, the hinges can be any known type of hinge, and for example may comprise acryl hinges which are bonded to the panel surfaces.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A tinted window assembly, comprising:
a polymer panel having a visible light transmission (VLT) of between about 5% and about 40%; and
a flexible trim having a channel portion engaged about a peripheral edge of said polymer panel and a compressible gasket portion extending from said channel portion,
wherein the polymer panel comprise a plurality of sections connected to one another via at least one hinge.

2. The tinted window assembly of claim 1, wherein said polymer panel has a shape and dimension that is slightly smaller than an aircraft window into which said tinted window assembly is to be installed, said gasket compressing into a window well surrounding said aircraft window to retain said tinted window assembly in an installed position adjacent said aircraft window.

3. The tinted window assembly of claim 1, wherein said polymer panel further comprises:
an intermediate bonding film on one side of said polymer panel; and
a tint film applied over said bonding film.

4. The tinted window assembly of claim 3, wherein said polymer panel is a material selected from the group consisting of: acrylic and polycarbonate

5. The tinted window assembly of claim 3, wherein said intermediate bonding film comprises a clear polyethelene terephthalate (PET) bonding film.

6. The tinted window assembly of claim 3, wherein said intermediate tint film comprises a tinted film having a VLT of between about 5% and about 40% clear.

7. The tinted window assembly of claim 1, wherein said polymer panel further comprises:
an intermediate bonding film on one side of said polymer panel, said bonding film cured for between 6 and 10 days; and
a tint film applied over said bonding film after said bonding film is cured, said tint film cured for between 2 and 4 additional days.

8. The tinted window assembly of claim 1, wherein said flexible trim further comprises:
a plurality of spring clips positioned within said channel portion, said spring clips engaging a peripheral edge of said polymer panel to assist in retaining said flexible trim thereon.

9. The tinted window assembly of claim 1, wherein said flexible trim further comprises
at least one blade gasket extending into said channel portion, said at least one blade gasket engaging a peripheral edge of said polymer panel to assist in retaining said flexible trim thereon.

10. The tinted window assembly of claim 1, wherein said gasket portion of said flexible trim further comprises a substantially tubular compressible sponge rubber material.

11. The tinted window assembly of claim 1, wherein said gasket portion of said flexible trim further comprises a substantially tubular compressible sponge rubber material formed from ethylene propylene diene monomer (EPDM).

12. The tinted window assembly of claim 1, further comprising:
at least one tab affixed adjacent an edge of said polymer panel to facilitate installation and removal thereof.

13. The tinted window assembly of claim 12, wherein said at least one tab extends through a slot formed adjacent said edge of said polymer panel.

14. The tinted window assembly of claim 1, further comprising:
at least two tabs, one affixed adjacent a top edge and one affixed adjacent a bottom edge of said polymer panel to facilitate installation and removal thereof.

15. The tinted window assembly of claim 14, wherein said at least two tabs extend through slots formed adjacent said top and bottom edges of said polymer panel.

16. The tinted window assembly of claim 4, further comprising:
at least one tab affixed adjacent an edge of said polymer panel to facilitate installation and removal thereof.

17. The tinted window assembly of claim 16, wherein said at least one tab extends through a slot formed adjacent said edge of said polymer panel.

18. The tinted window assembly of claim 5, further comprising:
at least one tab affixed adjacent an edge of said polymer panel to facilitate installation and removal thereof.

19. The tinted window assembly of claim 18, wherein said at least one tab extends through a slot formed adjacent said edge of said polymer panel.

20. The tinted window assembly of claim 1,
wherein the polymer panel comprise three sections,
wherein a first section is connected to a second section with a first set of two hinges, and
wherein the second section is connected to a third section with a second set of two hinges.
